(19) United States
(12) Patent Application Publication
(10) Pub. No.: US 2010/0138479 A1
(43) Pub. Date: Jun. 3, 2010

(54) Software operating system and the software-operating method thereof

(75) Inventor: Yi'e Zhu, Guangdong (CN)

Correspondence Address: MICHAEL N. LAU;LAU & ASSOCIATES, LLC, 2121 EISENHOWER AVENUE, SUITE 200, ALEXANDRIA, VA, 22314, US

(73) Assignees: Beijing Kingsoft Software Co., Limited; Zhuhai Kingsoft Software Co., Limited

(21) Appl. No.: 12/457,976

(22) Filed: Jun. 26, 2009

(30) Foreign Application Priority Data
Nov. 28, 2008 (CN) CN200810219547.5

(51) Int. Cl. G06F 15/16

(52) U.S. Cl. 709/203

(57) ABSTRACT

The present invention relates to a brand new software-operating method and a software operating system a software operating system comprising a client execution module positioned at the client and a server control and data distribution module positioned at the server; the client execution module further comprising: a process loading sub-module which acquires and loads a software package definition file and establishes an environment required for running an application program on the one hand; and directs the operating system to create a corresponding process for the application program to be executed on the other hand; an I/0 monitoring and processing sub-module which monitors and captures an I/O request of the application program; and a network communication sub-module which communicates with the server through the network according to the request, and downloads the corresponding data to a local computer; the server control and data distribution module further comprising: a control sub-module which coordinates the work between other server sub-modules and the client; and a data distribution sub-module which provides specific data in a software package to the client. For the present invention, because the files or subprograms which are not used are not needed to be loaded, thus greatly reducing the requirements for storage space of the client computer on the one hand, and preventing the procedure of installing the whole software at the client on the other hand.

### FIELD OF THE INVENTION

The present invention relates to a brand new software-operating method and a software operating system.

### BACKGROUND OF THE INVENTION

Firstly, some technical terms related to describing the application process are explained as follows:

Memory-file mapping mechanism: The I/O mechanism of an operating system, which maps the contents of a file to a section of address space of a process, and reads the contents of the file by accessing the memory address. In the bottom implementation, not all contents of the file are read in a physical memory, and the actually required parts are read in by a page fault processing mechanism of the operating system.

Program module file: A file which stores commands required when an application program is executed, and the operating system reads the data in the file via the memory-file mapping mechanism. For example, common files with the extension name of .EXE/.DLL belong to the program module files.

Data file: A file which an application program actively calls the I/O API function provided by the operating system to access when the application program is executed, and generally stores resource data such as configuration data, pictures, music and the like.

Software package: A data set to be used by the operation of one or a group of programs, and comprises files required by one or several pieces of software. For example, a WPS software package comprises the files required by three pieces of software, i.e. WPS word software, WPS demonstration software and WPS spreadsheet software.

Software package definition file: A file used for describing data items contained in a software package, and the data such as access addresses of the data items and the like.

Software source: Consisting of a software package and a software package definition file thereof, it represents a software package which can operate in a stream mode.

Logics or functions which can be implemented by a program are completed by a series of commands which can be understood and executed by the CPU. The commands are generally divided into subprograms (or referred to as sub-functions), and stored in one or multiple files which are referred to as program module files. The program can store part of the data required for accomplishing the program functions (such as program configuration, pictures, sound and the like) in an individual file according to the program design, the data are read and written by the I/O API function of the operating system when in use, and the files are referred to as data files.

Commands which constitute subprograms are required to be read into the memory before execution. A series of subprograms (sub-functions) are sequentially executed in one execution process of a program. Generally, the subprograms are not sequentially stored in one file, but are possibly distributed in different program module files. For example, an App program consists of three executable module files, i.e. an app. exe file, a foo.dll file and a bar.dll file. The app.exe file comprises subprograms A, B and C, the foo.dll file comprises a subprogram D, and the bar.dll file comprises a subprogram E. Provided that the order of calling the subprograms is A->D->B when the App program is initiated and the E is called by clicking a menu on an interface. The contents of corresponding locations in the app.exe file and the foo.dll file are required to be read into the memory according to requirements in order to complete the initiating process. And the section corresponding to the E in the bar.dll is required to be read into the memory after clicking the menu.

On the other hand, full contents of the three files are not used at any moment in the execution flow. The bar.dll file is not used in the initiating process. Although the app.exe file is required, the part which stores subprogram C is not used. Therefore, partial characters of using of files and data in the files exist in the program module files.

Data files are similar to the program module files. A program possibly does not read all data files or all sections of a file at a certain time. Therefore, partial characters of using of files and data in the files also exist in the data files.

Although the partial characters exist, the program can not continue the execution if the data required by a data execution flow is not satisfied. An internal execution flow of a given program is different and unpredictable according to different user operation modes and different input data; therefore, in a traditional mode, the program can be initiated after all files of the software package are installed by an installation program although some files and data in the software package will never be used. In such a way, the storage space loss of a computer and the time overhead for preparing the data are undoubtedly increased.

To sum up, the existing software operating method has two main disadvantages. The first disadvantage is that inadequate use (partial characters) of the files and the data of the files in the computer waste some storage space of the computer; the second disadvantage is that the existing software is required to be installed to a local computer before running, the computer is required to have larger storage space, and the installation process wastes time and energy.

However, if a mechanism can be realized to monitor use requests for data during execution of application programs, and can respectively satisfy the requests, then the programs can be operated without executing the installation process, thus saving the storage space of the local computer, and overcoming the two disadvantages at the same time.

### SUMMARY OF THE INVENTION

The present invention overcomes the disadvantages of the prior art. The first object of the present invention is to provide a software operating system; an application program can be operated in a data stream way by the system without locally installing software, and without locally storing a whole software source.

The second object of the present invention is to provide a software-operating method using the system.

In order to realize the first object, the present invention adopts the following technical solution:

A software operating system comprising a client execution module positioned at the client and a server control and data distribution module positioned at the server; the client execution module further comprising:
a process loading sub-module which acquires and loads a software package definition file and establishes an environment required for running an application program on the one hand; and directs the operating system to create a corresponding process for the application program to be executed on the other hand;
an I/O monitoring and processing sub-module which monitors and captures an I/O request of the application program; and
a network communication sub-module which communicates with the server through the network according to the request, and downloads the corresponding data to a local computer;
the server control and data distribution module further comprising:
a control sub-module which coordinates the work between other server sub-modules and the client; and
a data distribution sub-module which provides specific data in a software package to the client.

In order to realize the second object, the present invention adopts the following technical solution:

A software-operating method using said software operating system comprises the following procedures:
<1> the server control and data distribution module is installed in the server; the client execution module is installed in the client computer; and a software source of the software to be operated is deployed in the server;
<2> the process loading sub-module checks whether the software package definition file of the designated software source is cached to the client local computer; if not, the server is connected to download the software package definition file; and the process loading sub-module checks whether a working director corresponding to the software package exists; if not, a working directory corresponding to the software package is created;
<3> a full path of an executable file is obtained according to the location of the working directory and the file name of the executable file designated by the the process loading sub-module, and the process loading sub-module calls an API function of the operating system by taking the path as a parameter to direct the operating system to create a new process;
<4> the operating system opens the executable file pointed by the full path using the API function while creating the new process, and maps the content of the executable file to an address space of the process based on the ‘memory-file mapping mechanism’. If the executable file is dependent on other program module files, the operating system repeats the procedure, opens the program module files depended on, and maps the files to the address space; and the procedure is stopped until all the program module files depended on are opened and mapped to the address space; and
<5> the operating system starts to execute an entry function defined in the said executable file, and the entry function continues to call other functions of the file or other files according to the logic of the entry function; the CPU executes a reading operation on the address of each function while executing each function so as to obtain the contents of a command, decode and execute the command; a page fault is generated when file data corresponding to the address accessed by the CPU are not in a physical memory, the original execution process is suspended at the moment, a processing subprogram of the page fault initiates an I/O reading request for reading corresponding section of the corresponding file into the physical memory, and then continues the original execution process; the I/O monitoring and processing sub-module can monitor each I/O reading request, firstly checks whether the data to be read exist in the memory, reads out the data from the memory if yes, and returns the data to an upper caller to complete the reading operation; if the data do not exist in the memory, the I/O monitoring and processing sub-module requests the network communication sub-module to download the data from the server to the memory, and returns the data to the upper caller to complete the reading operation.

The software operating method adopted is a brand-new software operating mode (data flow mode). Only a small client operation environment, i.e. the client execution module, is installed in the client computer without installing whole software to be operated in the client computer; subprograms required for software execution are downloaded from the server in a data flow mode, and the files or subprograms which are not used are not needed to be loaded, thus greatly reducing the requirements for storage space of the client computer on the one hand, and preventing the procedure of installing the whole software at the client on the other hand. The software operating method has another advantage of enhancing software security; the software installed in the client computer is easy to be deciphered to produce pirated software, but the software using the present method has no software source at the client, thus the deciphering probability does not exist.

A further technical scheme is as follows:
the said method further comprises the following procedure:
<6> if the application program intends to read partial content of a data file, the I/O monitoring and processing sub-module monitors the I/O reading request, checks whether the data to be read exist in the memory, reads out the data from the memory if yes, and returns the data to an upper caller to complete the reading operation; if the data do not exist in the memory, the I/O monitoring and processing sub-module requests the network communication sub-module to download the data from the server to the memory, and returns the data to the upper caller to complete the reading operation.

General software operation also needs reading a data file, and the steps aim at a reading mechanism of the data file.

### BRIEF DESCRIPTION OF THE DRAWINGS

FIG. 1 illustrates a collective diagram of files in a WPS software package existing at the server.

FIG. 2 illustrates a structural diagram of a software operating system in the second embodiment.

The present invention will be described herein with reference to illustrative embodiments.

### DESCRIPTION OF EMBODIMENTS

### The First Embodiment

A software operating system comprising a client execution module positioned at the client, and a server control and data distribution module positioned at the server;

The client execution module further comprising:
a process loading sub-module which acquires and loads a software package definition file, and establishes an environment required for running an application program on the one hand; and directs the operating system to create a corresponding process for the application program to be executed on the other hand;
an I/O monitoring and processing sub-module which monitors and captures an I/O request of the application program, and calls a special processing procedure to process the request; the special processing procedure refers to, for example. ‘the I/O monitoring and processing sub-module can monitor each I/O reading request, firstly checks whether the data to be read exist in the memory, reads out the data from the memory if yes, and returns the data to an upper caller to complete the reading operation; if the data do not exist in the memory, the I/O monitoring and processing sub-module requests the network communication sub-module to download the data from the server to the memory, and returns the data to the upper caller to complete the reading operation’ mentioned in the fifth step of the following first embodiment; and refers to, for example, ‘the I/O monitoring and processing sub-module monitors an I/O request for opening a file sent via the operating system, checks whether the client has a corresponding cache file while completing the opening request by a standard file opening process of the operating system; if not, the cache management sub-module creates an initial cache file with null content’ mentioned in the fifth step of the second embodiment. and
a network communication sub-module which communicates with the server through the network according to the requests of other sub-modules, and downloads corresponding data to a local computer; and
the server control and data distribution module further comprising:
a control sub-module which coordinates the work between other server sub-modules and the client; and
a data distribution sub-module which provides specific data in the software package to the client.

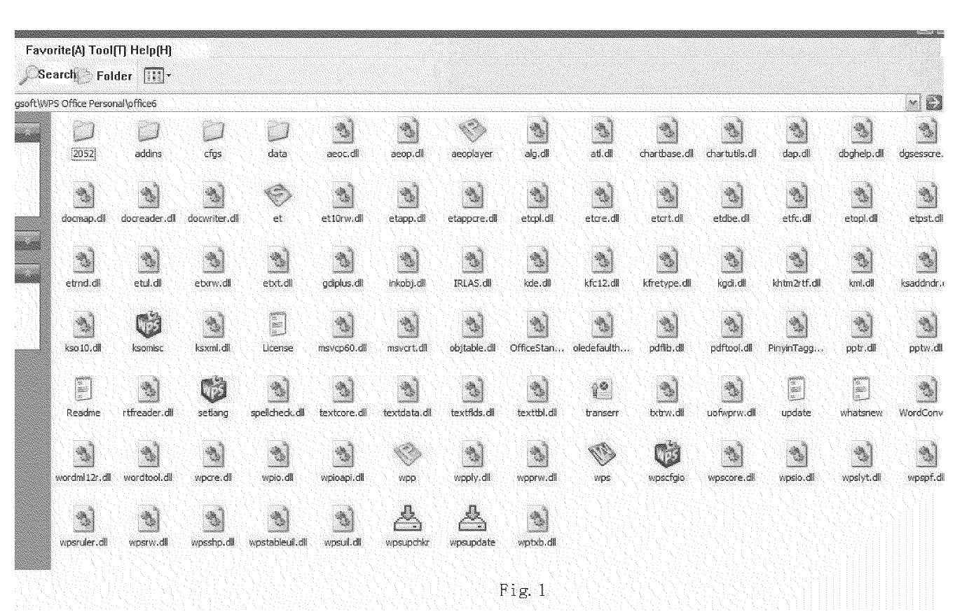

The software operating method using the software operating system is described by taking the WPS software as an example, and comprises the following procedures:
1. environment preparation. Modules related to the server are installed on the server; modules related to the client are installed on the client computer; a software source is made for a WPS application program by an auxiliary tool (a premade software source can also be adopted), the software source comprises a WPS software package and a software package definition file illustrated in FIG. 1, and the software package comprises files required by three pieces of software, i.e. WPS word software, WPS demonstration software and WPS spreadsheet software. The software source is deployed on the server, which is described by taking the example that a user prepares to use a WPS word application program. And then, the end user operates the client execution module on the client computer to provide information such as a network address, software source names, file names of executable programs and the like of the server so as to initiate the whole execution process;
2. the process loading sub-module checks whether the software package definition file of the software source is cached to the client local computer; if not, the server is connected to download the software package definition file; and and the process loading sub-module checks whether a working directory corresponding to the software package exists in a pre-configured location; if not, a working directory is created; The pre-configured location can be an optional location of a local disk, for example, a ‘WPS word’ folder in C:\Program Files\Kingsoft;
3. a full path of the WPS file can be obtained according to the location of the working directory (C:\Program Files\Kingsoft\ WPS Word) and the file name of the executable file (the WPS file in FIG. 1) designated by the user, and the process loading sub-module calls an API function of the operating system by taking the path as a parameter to direct the operating system to create a new process;
4. the operating system opens the executable file WPS pointed by the full path using the API function while creating the new process, but the file WPS does not exist in the local computer, only a null file which is called WPS and located in the ‘WPS word’ folder exists in the local computer (the WPS null file is referred to as ‘WPS null’ to prevent confusion from the WPS file), so the content of the WPS file is mapped to an address space of the process based on the ‘memory-file mapping mechanism’. If the WPS file is dependent on other executable module files (using functions in other modules, for example, wpscore.dll), the operating system repeats the procedure, opens the wpscore.dll file, and maps the wpscore.dll file to the address space; and the procedure is stopped until all the files depended on are opened and mapped to the address space;
5. then the operating system starts to execute the entry function defined in the WPS file, and the entry function continues to call other functions of the file or other files according to the logic of the entry function. The CPU executes a reading operation on the address of each function while executing each function so as to obtain the contents of the command, decode and execute the command. As the operating system creates a mapping relation between the addresses and the executable module files by the ‘memory-file mapping mechanism’, a page fault is generated when file data corresponding to the addresses accessed by the CPU are not in the physical memory, and the original execution process is suspended at the moment. A processing subprogram of the page fault initiates an I/O reading request for reading corresponding sections of the corresponding files into the physical memory, and then continues the original execution process. The I/O monitoring and processing sub-module can monitor each I/O reading request, firstly checks whether the data to be read exist in the memory, reads out the data from the memory if yes, and returns the data to an upper caller to complete the reading operation; if the data do not exist in the memory, the I/O monitoring and processing sub-module requests the network communication sub-module to download the data from the server to the memory, and return the data to the upper caller to complete the reading operation; and
6. similarly, if the application program intends to read partial content of a data file (such as a file in a folder ‘data’), the I/O monitoring and processing sub-module monitors the I/O reading request, checks whether the data to be read exist in the memory, reads out the data from the memory if yes, and returns the data to the upper caller to complete the reading operation; if the data do not exist in the memory, the I/O monitoring and processing sub-module requests the network communication sub-module to download the data from the server to the memory, and returns the data to the upper caller to complete the reading operation.

Finally, when the application program is completed, the client execution module monitors the action and executes corresponding resource cleanup work.

### The Second Embodiment

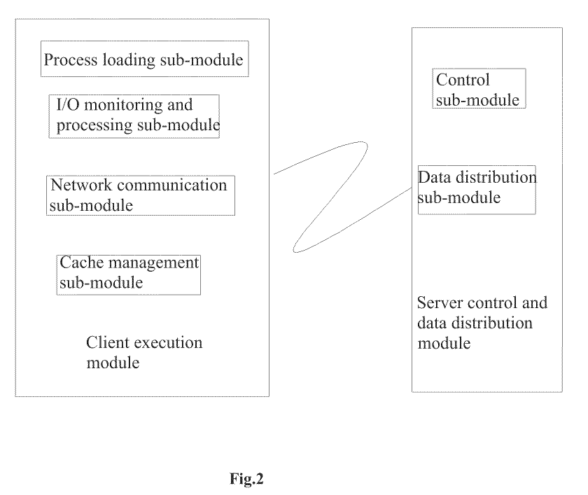

The differences between this embodiment and the first embodiment are that a cache management sub-module (refer to FIG. 2) is added based on the software operating system of the first embodiment; the cache management sub-module is part of the client execution module, and has the main effect of locally caching the data downloaded from the server so as to accelerate the subsequent operation requests. From step 5 and step 6 in the software operating method of the first embodiment, the data to be read and downloaded from the server are stored in the memory, but the data in the memory are updated all the time. The data need to be downloaded from the server again when required the next time, and the operating speed can be slightly restricted, which is troublesome. The cache management sub-module can temporarily store the downloaded data into a certain local space; therefore, the data can be searched in the local space when required the next time, and the data do not need to be downloaded again if the data are stored in the local space.

Accordingly, the software operating method of the embodiment is different from that of the first embodiment. The 1^{st} to 4^{th} steps of the embodiment are the same as those of the first embodiment, which are not repeated herein, and the next procedures are as follows:
5. the I/O monitoring and processing sub-module monitors an I/O request for opening a file sent via the operating system, checks whether the client local computer has a corresponding cache file while completing the opening request via a standard file opening process of the operating system, if not, the cache management sub-module creates an initial cache file with null content;
6. the operating system starts to execute an entry function defined in the executable file, and the entry function continues to call other functions of the file or other files according to the logic of the entry function; the CPU executes a reading operation on the address of each function while executing each function so as to obtain the contents of the command, and decode and execute the command; a page fault is generated when file data corresponding to the address accessed are not in the physical memory, the original execution process is suspended at the moment, a processing subprogram of the page fault initiates an I/O reading request for reading corresponding sections of the corresponding file into the physical memory, and then continues the original execution process; the I/O monitoring and processing sub-module can monitor each I/O reading request, firstly checks whether the data to be read exist in the cache file corresponding to the file, reads out the data from the cache file if yes, and returns the data to an upper caller to complete the reading operation; if the data do no exist in the cache file, the I/O monitoring and processing sub-module requests the network communication sub-module to download the data from the server to the memory, writes the data in the cache file, and returns the data to the upper caller to complete the reading operation; and
7. similarly, if an application program intends to read partial content of a data file, the I/O monitoring and processing sub-module monitors the I/O reading request, checks whether the data to be read exist in the cache file corresponding to the file, reads out the data from the cache file if yes, and returns the data to an upper caller to complete the reading operation; if the data do not exist in the cache file, the I/O monitoring and processing sub-module requests the network communication sub-module to download the data from the server to the memory, writes the data in the cache file, and returns the data to the upper caller to complete the reading operation.

Finally, when the application program is completed, the client execution module monitors the action and executes corresponding resource cleanup work, for example, cleaning the cache file, the ‘WPS null’ file in the working directory and the like.

The embodiments described above only serve as examples of how to realize the present invention, not to limit its technical solution. It is understood by those skilled in the art that changes or partial modifications made without departing from the principle or spirit described above fall within the scope of the claims of the present invention.

1. A software operating system, comprising a client execution module located at a client site, and a server control and data distribution module located at a server site;
the client execution module further comprising:
a process loading sub-module which acquires and loads software package definition files and establishes an environment required for running an application program, and directs the operating system to create a corresponding process for the application program to be executed;
an I/O monitoring and processing sub-module which monitors and captures an I/O request of the application program; and
a network communication sub-module which communicates with the server through the network according to the I/O request, and downloads the corresponding data to the local computer;
the server control and data distribution module further comprising:
a control sub-module which coordinates the work between other server sub-modules and the client; and
a data distribution sub-module which provides specific data in a software package to the client.

2. A software operating system according to claim 1, wherein the client execution module further comprises a cache management sub-module which caches the data downloaded from the server to the client to accelerate a subsequent operation request.

3. A software-operating method of an operating system comprising a plurality of steps of:
<1> a server control and data distribution module is installed in a server; a client execution module is installed in a client computer; and a source of the software to be operated is deployed in the server;
<2> a process loading sub-module checks whether a software package definition file of a designated software source is cached to the client computer; if not, the server is connected to download the software package definition file; and a process loading sub-module checks whether a working directory corresponding to the software package exists; if not, a working directory corresponding to the software package is created;
<3> a full path of an executable file is obtained according to a location of the working directory and a file name of the executable file designated by the process loading sub-module, and the process loading sub-module calls an API function of the operating system by taking a path as a parameter to direct the operating system to create a new process;
<4> the operating system opens an executable file pointed by the path using the API function while creating the new process, and maps the contents of the executable file to an address space of the process based on a ‘memory-file mapping mechanism’; if the executable file is dependent on other program module files, the operating system repeats the procedure, opens the program module files, and maps the files to the address space; and the procedure is stopped until all the program module files depended on are opened and mapped to the address space; and
<5> the operating system starts to execute an entry function defined in the said executable file, and the entry function continues to call other functions of the file or other files according to the logic of the entry function; a CPU executes a reading operation on the address of each function while executing each function to obtain the content of a command, decode and execute the command; a page fault is generated when file data corresponding to the address accessed by the CPU are not in a physical memory, the original execution process is suspended at the moment, a processing subprogram of the page fault initiates an I/O reading request for reading corresponding section of the corresponding file into the physical memory, and then continues the original execution process; the I/O monitoring and processing sub-module can monitor each I/O reading request, firstly checks whether the data to be read exist in the memory, reads out the data from the memory if yes, and returns the data to an upper caller to complete the reading operation; if the data do not exist in the memory, the I/O monitoring and processing sub-module requests the network communication sub-module to download the data from the server to the memory, and returns the data to the upper caller to complete the reading operation.

4. A software-operating method of an operating system according to claim 3 further comprising a step of:
<7> when the application program is ended, the client execution module monitors the action and executes a corresponding resource cleanup work.

5. A software-operating method of an operating system according to claim 3, further comprising a step of:
<6> if the application program attempts to read partial content of a data file, the I/O monitoring and processing sub-module monitors the I/O reading request, checks whether the data to be read exist in the memory, reads out the data from the memory if yes, and returns the data to the upper caller to complete the reading operation; if the data do not exist in the memory, the I/O monitoring and processing sub-module requests the network communication sub-module to download the data to the memory, and returns the data to the upper caller to complete the reading operation.

6. A software-operating method of an operating system according to claim 5, further comprising a step of:
<7> when the application program is ended, the client execution module monitors the action and executes corresponding resource cleanup work.

7. A software-operating method of a software operating system comprising a plurality of steps of:
<1> a server control and data distribution module is installed in a server; a client execution module is installed in a client computer; and a software source is made for the software to be operated, and the software source is deployed in the server;
<2> a process loading sub-module checks whether a software package definition file of a designated software source is cached to the client computer; if not, the server is connected to download the software package definition file; and the process loading sub-module checks whether a working directory corresponding to the software package exists in a pre-configured location; if not, a working directory corresponding to the software package is created;
<3> a full path of an executable file is obtained according to a location of the working directory and a file name of an executable file designated by the process loading sub-module, and the process loading sub-module calls an API function of the operating system by taking the path as a parameter to direct the operating system to create a new process;
<4> the operating system opens the executable file pointed by the full path using the API function while creating the new process, and mapped the content of the executable file to an address space of the process based on a ‘memory-file mapping mechanism’; if the executable file is dependent on other program module files, the operating system repeats the procedure, opens the program module files, and mapped the files to the address space; the procedure is stopped until all the dependent files are opened and mapped to the address space;
<5> an I/O monitoring and processing sub-module monitors an I/O request for opening a file sent by the operating system, checks whether the client computer has a corresponding cache file while completing the opening request by a standard file opening process of the operating system; if not, the cache management sub-module creates an initial cache file with null content; and
<6> the operating system starts to execute an entry function defined in the executable file, and the entry function continues to call other functions of the file or other files according to the logic of an entry function; a CPU executes a reading operation on the address of each function while executing each function to obtain the contents of a command, decode and execute the command; a page fault is generated when file data corresponding to the address accessed by the CPU are not in a physical memory, the original execution process is suspended at the moment, a processing subprogram of the page fault initiates an I/O reading request for reading corresponding section of the corresponding file into the physical memory, and then continues the original execution process; the I/O monitoring and processing sub-module can monitor each I/O reading request, firstly checks whether the data to be read exist in the cache file corresponding to the file, reads out the data from the cache file if yes, and returns the data to an upper caller to complete the reading operation; if the data do not exist in the cache file, the I/O monitoring and processing sub-module requests the network communication sub-module to download the data from the server to the memory, writes the data in the cache file, and returns the data to the upper caller to complete the reading operation.

8. A software-operating method of an operating system according to claim 7, further comprising a step of:
<8> when the application program is ended, the client execution module monitors the action and executes corresponding resource cleanup work.

9. A software-operating method of an operating system according to claim 7, further comprising a step of:
<7> if the application program attempts to read partial content of a data file, the I/O monitoring and processing sub-module monitors the I/O reading request, checks whether the data to be read exist in the cache file corresponding to the file, reads out the data from the cache file if yes, and returns the data to the upper caller to complete the reading operation; if the data do not exist in the cache file, the I/O monitoring and processing sub-module requests the network communication sub-module to download the data from the server to the memory, writes the data in the cache file, and returns the data to the upper caller to complete the reading operation.

10. A software-operating method of an operating system according to claim 9, further comprising a plurality of steps of:
<8> when the application program is ended, the client execution module monitors the action and executes corresponding resource cleanup work.
